(19) United States
(12) Patent Application Publication
(10) Pub. No.: US 2026/0361389 A1
(43) Pub. Date: Nov. 12, 2026

(54) UPLINK BEAM MANAGEMENT

(71) Applicant: Telefonaktiebolaget LM Ericsson (publ), Stockholm (SE)

(72) Inventors: Andreas NILSSON, Göteborg (SE); Sven JACOBSSON, Västra Frölunda (SE); Fredrik ATHLEY, Västra Frölunda (SE)

(73) Assignee: Telefonaktiebolaget LM Ericsson (publ), Stockholm (SE)

(21) Appl. No.: 19/134,819

(22) PCT Filed: Dec. 6, 2022
(86) PCT No.: PCT/EP2022/084675

§ 371 Date: Jun. 2, 2025

(51) Int. Cl. H04B 7/06; H04B 7/024; H04B 7/0408; H04B 7/0413; H04L 5/00; H04W 72/044

(52) U.S. Cl. CPC H04B 7/06966; H04B 7/024; H04B 7/0408; H04B 7/0413; H04B 7/06956; H04L 5/0048; H04W 72/046

(57) ABSTRACT

A method of a wireless communication user device is disclosed, wherein the wireless communication user device comprises two or more antenna panels. The method is for determination of a beam to be used for uplink (UL) communication with a wireless communication network. The method comprises receiving (from the network) an uplink reference signal (UL RS) configuration for hierarchical UL beam management, wherein the UL RS configuration indicates a first collection of resources and a second collection of resources. The method also comprises transmitting UL RSs with a first beam width in the first collection of resources using different ones of the antenna panels, receiving (from the network) a first selection indication of one or more selected antenna panel, transmitting UL RSs with a second beam width in the second collection of resources using the one or more selected antenna panel, wherein the second beam width is more narrow than the first beam width, and receiving (from the network) a second selection indication of one or more selected beam with the second beam width. A corresponding method of a network node is also disclosed, as well as corresponding computer program product, apparatuses, wireless communication user device, and network node.

### TECHNICAL FIELD

The present disclosure relates generally to the field of wireless communication. More particularly, it relates to uplink beam management in the context of wireless communication.

### BACKGROUND

When beamforming is used for wireless communication, an approach need to be applied for selecting which beam(s) to use.

Typically, such an approach is based on using each prospect beam in a respective transmission resource for transmission of reference signaling so that the intended receiver device can perform measurements on the reference signaling. Then, a beam selection decision may be based on the result of the measurements.

A problem in this respect is that exhaustive reference signaling for all prospect beams typically introduces substantial signaling overhead and/or latency.

Therefore, there is a need for alternative approaches to beam management.

### SUMMARY

It should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Generally, when an arrangement is referred to herein, it is to be understood as a physical product; e.g., an apparatus. The physical product may comprise one or more parts, such as controlling circuitry in the form of one or more controllers, one or more processors, or the like.

It is an object of some embodiments to solve or mitigate, alleviate, or eliminate at least some of the above or other disadvantages.

A first aspect is a method of a wireless communication user device for determination of a beam to be used for uplink (UL) communication with a wireless communication network, wherein the wireless communication user device comprises two or more antenna panels. The method comprises receiving (from the network) an uplink reference signal (UL RS) configuration for hierarchical UL beam management. The UL RS configuration indicates a first collection of resources and a second collection of resources. The method also comprises transmitting UL RSs with a first beam width in the first collection of resources using different ones of the antenna panels, and receiving (from the network) a first selection indication of one or more selected antenna panel. Furthermore, the method comprises transmitting UL RSs with a second beam width in the second collection of resources using the one or more selected antenna panel, wherein the second beam width is more narrow than the first beam width, and receiving (from the network) a second selection indication of one or more selected beam with the second beam width.

In some embodiments, the method further comprises transmitting—before receiving the UL RS configuration—an UL RS capability message, indicating that the wireless communication user device supports hierarchical UL beam management.

In some embodiments, the UL RS capability message further indicates one or more of: a number of antenna panels of the wireless communication user device, a number of antenna panels that the wireless communication user device is capable of transmitting simultaneously from, a number of beams with the second beam width per antenna panel, and a time duration for panel switching.

In some embodiments, the method further comprises receiving (from the network) an UL RS triggering signal. In such embodiments, transmitting UL RSs with the first beam width in the first collection of resources using different ones of the antenna panels may be responsive to receiving the UL RS triggering signal.

In some embodiments, the first selection indication and/or the second selection indication is comprised in one or more of: downlink control information, DCI, a control element for medium access control, MAC-CE, and radio resource control, RRC.

In some embodiments, a same information field is used for the first selection indication and the second selection indication.

In some embodiments, at least two of the two or more antenna panels of the wireless communication user device are faced in different directions.

In some embodiments, an UL RS transmitted in the first collection of resources and/or in the second collection of resources comprises a sounding reference signal (SRS).

In some embodiments, transmitting UL RSs with the second beam width in the second collection of resources using the one or more selected antenna panel occurs more often than transmitting UL RSs with the first beam width in the first collection of resources using different ones of the antenna panels occurs.

A second aspect is a method of a network node for determination of a beam to be used for uplink (UL) communication with a wireless communication user device, that comprises two or more antenna panels. The method comprises causing transmission (to the wireless communication user device) of an uplink reference signal (UL RS) configuration for hierarchical UL beam management. The UL RS configuration indicates a first collection of resources and a second collection of resources. The method also comprises causing measurements to be performed on UL RSs transmitted by the wireless communication user device with a first beam width in the first collection of resources using different ones of the antenna panels, selecting one or more antenna panel based on the measurements performed on UL RSs transmitted by the wireless communication user device with a first beam width in the first collection of resources using different ones of the antenna panels, and causing transmission (to the wireless communication user device) of a first selection indication of the one or more selected antenna panel. Furthermore, the method comprises causing measurements to be performed on UL RSs transmitted by the wireless communication user device with a second beam width in the second collection of resources using the one or more selected antenna panel, wherein the second beam width is more narrow than the first beam width, selecting one or more beam based on the measurements performed on UL RSs transmitted by the wireless communication user device with a second beam width in the second collection of resources using the one or more selected antenna panel, and causing transmission (to the wireless communication user device) of a second selection indication of one or more selected beam with the second beam width.

In some embodiments, the method further comprises receiving—before transmission of the UL RS configuration—an UL RS capability message, indicating that the wireless communication user device supports hierarchical UL beam management.

In some embodiments, the configuration in relation to the first collection of resources is based on one or more of: the number of antenna panels of the wireless communication user device, the number of antenna panels that the wireless communication user device is capable of transmitting simultaneously from, and the time duration for panel switching. In some embodiments, the configuration in relation to the second collection of resources is based on the number of beams with the second beam width per antenna panel.

In some embodiments, the method further comprises causing transmission (to the wireless communication user device) of an UL RS triggering signal to provoke transmission (by the wireless communication user device) of UL RSs with the first beam width in the first collection of resources using different ones of the antenna panels.

In some embodiments, selecting one or more antenna panel comprises selecting one or more radio access nodes based on the measurements performed on UL RSs transmitted by the wireless communication user device with a first beam width in the first collection of resources using different ones of the antenna panels, and selecting a corresponding antenna panel for each selected radio access node.

In some embodiments, the method further comprises causing the wireless communication user device to transmit UL RSs with the second beam width in the second collection of resources using the one or more selected antenna panel occurs more often than UL RSs with the first beam width in the first collection of resources using different ones of the antenna panels occurs.

A third aspect is a computer program product comprising a non-transitory computer readable medium, having thereon a computer program comprising program instructions. The computer program is loadable into a data processing unit and configured to cause execution of the method according to any of the first and second aspects when the computer program is run by the data processing unit.

A fourth aspect is an apparatus for a wireless communication user device, for determination of a beam to be used for uplink (UL) communication with a wireless communication network, wherein the wireless communication user device comprises two or more antenna panels. The apparatus comprises controlling circuitry. The controlling circuitry is configured to cause reception (from the network) of an uplink reference signal (UL RS) configuration for hierarchical UL beam management, wherein the UL RS configuration indicates a first collection of resources and a second collection of resources. The controlling circuitry is also configured to cause transmission of UL RSs with a first beam width in the first collection of resources using different ones of the antenna panels, and reception (from the network) of a first selection indication of one or more selected antenna panel. Furthermore, the controlling circuitry is configured to cause transmission of UL RSs with a second beam width in the second collection of resources using the one or more selected antenna panel, wherein the second beam width is more narrow than the first beam width, and reception (from the network) of a second selection indication of one or more selected beam with the second beam width.

A fifth aspect is a wireless communication user device comprising the apparatus of the fourth aspect.

A sixth aspect is an apparatus for a network node, for determination of a beam to be used for uplink (UL) communication with a wireless communication user device, wherein the wireless communication user device comprises two or more antenna panels. The apparatus comprises controlling circuitry. The controlling circuitry is configured to cause transmission (to the wireless communication user device) of an uplink reference signal (UL RS) configuration for hierarchical UL beam management, wherein the UL RS configuration indicates a first collection of resources and a second collection of resources. The controlling circuitry is also configured to cause measurements on UL RSs transmitted by the wireless communication user device with a first beam width in the first collection of resources using different ones of the antenna panels, selection of one or more antenna panel based on the measurements performed on UL RSs transmitted by the wireless communication user device with a first beam width in the first collection of resources using different ones of the antenna panels, and transmission (to the wireless communication user device) of a first selection indication of the one or more selected antenna panel. Furthermore, the controlling circuitry is configured to cause measurements on UL RSs transmitted by the wireless communication user device with a second beam width in the second collection of resources using the one or more selected antenna panel, wherein the second beam width is more narrow than the first beam width, selection of one or more beam based on the measurements performed on UL RSs transmitted by the wireless communication user device with a second beam width in the second collection of resources using the one or more selected antenna panel, and transmission (to the wireless communication user device) of a second selection indication of one or more selected beam with the second beam width.

A seventh aspect is a network node comprising the apparatus of the sixth aspect.

In some embodiments, the network node is a base station.

In some embodiments, the network node is a coordinating node for multiple transmission points (multi-TRP).

In some embodiments, the network node is a central processing node for a distributed multiple-input multiple output (D-MIMO) system.

In some embodiments, any of the above aspects may additionally have features identical with or corresponding to any of the various features as explained above for any of the other aspects.

An advantage of some embodiments is that alternative approaches to uplink beam management are provided.

An advantage of some embodiments is that signaling overhead due to beam selection reference signaling is reduced compared to other approaches.

An advantage of some embodiments is that beam selection latency is reduced compared to other approaches.

An advantage of some embodiments is that approaches for uplink beam management are provided, which are suitable for situations where a wireless communication user device that comprises two or more antenna panels.

An advantage of some embodiments is that approaches for uplink beam management are provided, which are suitable for distributed multiple-input multiple output (D-MIMO).

An advantage of some embodiments is that approaches for uplink beam management are provided, which are suitable for multiple transmission point (multi-TRP) deployments.

An advantage of some embodiments is that approaches for uplink beam management are provided, which are suitable for situations where a network node supports a communication mode with only uplink signaling (e.g., an “UL only” network node).

### BRIEF DESCRIPTION OF THE DRAWINGS

Further objects, features and advantages will appear from the following detailed description of embodiments, with reference being made to the accompanying drawings. The drawings are not necessarily to scale, emphasis instead being placed upon illustrating the example embodiments.

FIG. 1 is a flowchart illustrating example method steps according to some embodiments;

FIG. 2 is a flowchart illustrating example method steps according to some embodiments;

FIG. 3 is a signaling diagram illustrating example signaling according to some embodiments;

FIG. 4A is a schematic drawing illustrating example collections of resources according to some embodiments;

FIG. 4B is a schematic drawing illustrating example collections of resources according to some embodiments;

FIG. 5 is a schematic block diagram illustrating an example apparatus according to some embodiments;

FIG. 6 is a schematic block diagram illustrating an example apparatus according to some embodiments;

FIG. 7 is a schematic block diagram illustrating an example wireless communication user device according to some embodiments;

FIG. 8 is a schematic block diagram illustrating an example wireless communication context according to some embodiments; and

FIG. 9 is a schematic drawing illustrating an example computer readable medium according to some embodiments.

### DETAILED DESCRIPTION

As already mentioned above, it should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

Generally, when a wireless communication user device (also referred to as a user device) is referred to herein, it is meant to encompass any suitable wireless communication user device. For example, the wireless communication user device may be a user equipment (UE) compliant with third generation partnership (3GPP) standardization and/or a station (STA) compliant with IEEE 802.11 standardization.

Also generally, when a network node is referred to herein, it is meant to encompass any suitable network node. For example, the network node may be a radio access node, such as a base station (BS; e.g., a gNB) compliant with third generation partnership (3GPP) standardization and/or an access point (AP) compliant with IEEE 802.11 standardization. Alternatively or additionally, the network node may be a control node for a plurality of radio access nodes, such as a coordinating node for multi-TRP or a central processing node for a D-MIMO system.

Also generally, when a wireless communication network (also referred to as a network) is referred to herein, it is meant to encompass any suitable wireless communication network. For example, the wireless communication network may be a network compliant with third generation partnership (3GPP) standardization and/or IEEE 802.11 standardization. Alternatively or additionally, the wireless communication network may be a D-MIMO system.

In the following, approaches to uplink beam management will be presented and exemplified for contexts when a wireless communication user device comprises two or more antenna panels, wherein an (e.g., each) antenna panel is associated with a number of respective prospect beams. In such contexts, the number of prospect beams may be relatively large, and uplink (UL) beam selection based on exhaustive reference signaling for all prospect beams typically introduces substantial signaling overhead and/or latency. This is addressed by some embodiments by hierarchical UL beam management.

The hierarchical UL beam management comprises a first hierarchy level and a second hierarchy level. The first hierarchy level comprises UL RS transmission using a few beams (e.g., a single beam) per antenna panel and relatively broad beam width. The second hierarchy level comprises UL RS transmission only from antenna panel(s) selected based on the UL RS transmission of the first hierarchy level. The UL RS transmission of the second hierarchy level uses a beam width which is more narrow than that of the first hierarchy level, and typically uses a larger number of beams per antenna panel than the first hierarchy level; e.g., all beams of the selected antenna panel(s).

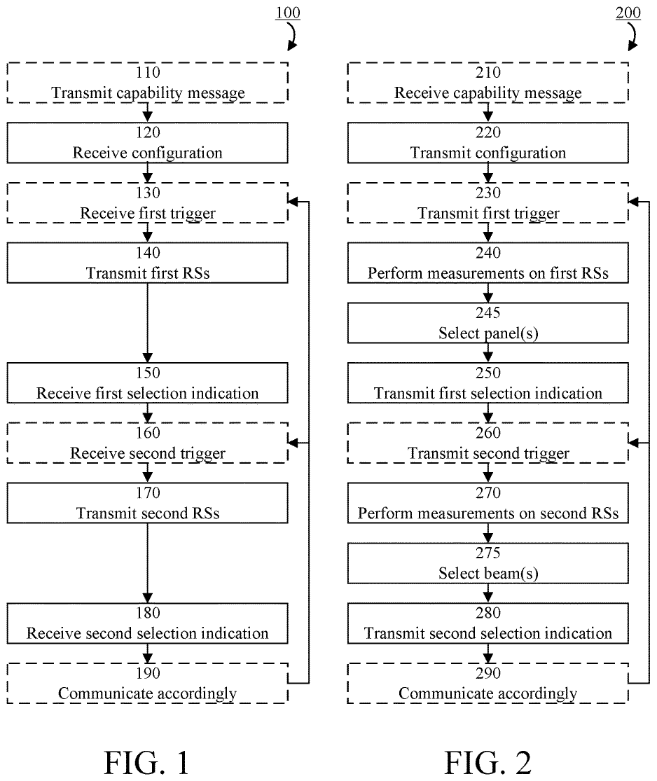

FIG. 1 illustrates an example method 100 according to some embodiments and FIG. 2 illustrates an example method 200 according to some embodiments. The method 100 is a method of a wireless communication user device comprising two or more antenna panels (some/all of which may be faced in different directions), and the method 200 is a corresponding method of a wireless communication network; e.g., for a network node of the wireless communication network.

The methods 100, 200 are for determination of a beam to be used for uplink (UL) communication between the wireless communication user device and the wireless communication network.

In step 220, the network transmits an uplink reference signal (UL RS) configuration for hierarchical UL beam management, which is received by the user device is step 120. The transmission of step 220 may be performed by a radio access node of the network. In some embodiments, the transmission of step 220 is caused by a control node of the network; e.g., via control signaling to the radio access node.

The UL RS configuration indicates a first collection of resources and a second collection of resources. The resources of the first and second collection may be any suitable communication resources; e.g., time resources, frequency resources, signal signature resources, code resources, antenna ports, or any combination thereof. Typically, the resources of the second collection occurs later in time than the resources of the first collection.

The UL RS configuration may be transmitted in any suitable way in step 220. For example, the UL RS configuration may be conveyed by RRC signaling and/or MAC-CE signaling.

In step 140, the user device transmits UL RSs with a first beam width in the first collection of resources using different ones (typically all) of the antenna panels. Typically, step 140 comprises using respective (different) resources of the first collection for different antenna panels (and different beams).

The transmission of step 140 typically comprises transmission of one single beam per antenna panel, but may comprise transmission of two or more beams for one or more of the antenna panels in some embodiments.

The first beam width is typically a relatively broad beam width. For example, the first beam width may correspond to the broadest possible beam width for the antenna panel.

The transmission of step 140 may be caused by the network.

For example, as illustrated by optional steps 230 and 130, the network may transmit an UL RS triggering signal to provoke the transmission of step 140. The transmission of step 230 may be performed by a radio access node of the network. In some embodiments, the transmission of step 230 is caused by a control node of the network; e.g., via control signaling to the radio access node. As illustrated by optional step 130, the UL RS triggering signal may be received by the user device, and the transmission of step 140 may be responsive to receiving the UL RS triggering signal.

Alternatively or additionally, the UL RS configuration transmitted in step 220 may indicate when the transmission of step 140 is to occur (implicitly triggering the transmission of step 140).

In step 240, measurements are performed on the UL RSs transmitted in step 140. The measurements may be any suitable measurements suitable for panel/beam selection; e.g., measurements according to the prior art. Example measurements suitable for panel/beam selection include measurements on received signal strength, reference signal received power (RSRP), reference signal received quality (RSRQ), and similar. The measurements of step 240 may be performed by a radio access node of the network. In some embodiments, the measurements of step 240 are caused by a control node of the network; e.g., via control signaling to the radio access node.

In step 245, one or more antenna panel are selected by the network, based on the measurements of step 240. The selection of step 245 may be performed by a radio access node of the network or by a control node of the network. The selection of step 245 may comprise any suitable selection approach. For example, the selection of step 245 may be an implicit selection of a panel; e.g., comprising selection of one of the resources of the first collection based on the measurements performed for that resource (and other resources of the first collection).

The selection of step 245 may comprise selecting a panel which is associated with a highest measurement value (e.g., highest signal strength) among the measurements for the first collection of resources, or which is associated with a measurement value above a threshold value (e.g., signal strength above a threshold value).

For D-MIMO and/or multi-TRP deployments, the selection of step 245 may comprise selecting one or more radio access node (i.e., a D-MIMO AP, or a TRP) based on the measurements of step 240, and selecting a corresponding antenna panel for each selected radio access node. For example, the radio access node(s) may be selected, which registered (for any of the resources of the first collection) highest measurement value(s) among the radio access nodes, or which registered measurement value(s) above a threshold value. Then, the corresponding antenna panel for each selected radio access node may be selected as described above.

In step 250, the network transmits a first selection indication of the one or more selected antenna panel(s), which is received by the user device is step 150. The transmission of step 250 may be performed by a radio access node of the network. In some embodiments, the transmission of step 250 is caused by a control node of the network; e.g., via control signaling to the radio access node.

The first indication may be any suitable indication for identification of the selected antenna panel(s). For example, the first indication may explicitly identify the selected antenna panel(s); e.g., using respective panel indices, or similar. Alternatively or additionally, the first indication may implicitly identify the selected antenna panel(s); e.g., by indicating corresponding selected resource(s) of the first collection, in which case the user device may be configured to map the indicated resource to the corresponding antenna panel.

In step 170, the user device transmits UL RSs with a second beam width in the second collection of resources using the selected antenna panel(s). Typically, step 170 comprises using respective (different) resources of the second collection for different beams.

The second beam width is more narrow than the first beam width. Typically, the second beam width is a relatively narrow beam width. For example, the second beam width may correspond to the narrowest possible beam width for the antenna panel.

The transmission of step 170 typically comprises transmission of several beams (e.g., all of the narrowest beams) per selected antenna panel. For example, the transmission of step 170 may comprise a beam sweep for the selected antenna panel(s).

### The Transmission of Step 170 May Be Caused by the Network.

For example, as illustrated by optional steps 260 and 160, the network may transmit an UL RS triggering signal to provoke the transmission of step 170. The transmission of step 260 may be performed by a radio access node of the network. In some embodiments, the transmission of step 260 is caused by a control node of the network; e.g., via control signaling to the radio access node. As illustrated by optional step 160, the UL RS triggering signal may be received by the user device, and the transmission of step 170 may be responsive to receiving the UL RS triggering signal.

Alternatively or additionally, the UL RS configuration transmitted in step 220 may indicate when the transmission of step 170 is to occur (implicitly triggering the transmission of step 170).

Yet alternatively or additionally, the UL RS triggering signal of step 230 may indicate when the transmission of step 170 is to occur (implicitly triggering the transmission of step 170).

Yet alternatively or additionally, the first selection indication of step 250 may implicitly trigger the transmission of step 170.

It should be noted that the methods 100, 200 may comprise only the UL RS triggering signal of step 230, only the UL RS triggering signal of step 260, the UL RS triggering signals of steps 230 and 260 (first and second UL RS triggering signals, respectively), or no explicit UL RS triggering signal.

In step 270, measurements are performed on the UL RSs transmitted in step 170. The measurements may be any suitable measurements suitable for beam selection; e.g., measurements according to the prior art. Example measurements suitable for beam selection include measurements on received signal strength, reference signal received power (RSRP), reference signal received quality (RSRQ), and similar. The measurements of step 270 may be performed by a radio access node of the network. In some embodiments, the measurements of step 270 are caused by a control node of the network; e.g., via control signaling to the radio access node.

In step 275, one or more beam are selected by the network, based on the measurements of step 270. The selection of step 275 may be performed by a radio access node of the network or by a control node of the network.

The selection of step 275 may comprise any suitable selection approach. For example, the selection of step 275 may be an implicit selection of a beam; e.g., comprising selection of one of the resources of the second collection based on the measurements performed for that resource (and other resources of the second collection).

The selection of step 275 may comprise selecting a beam which is associated with a highest measurement value (e.g., highest signal strength) among the measurements for the second collection of resources, or which is associated with a measurement value above a threshold value (e.g., signal strength above a threshold value).

In step 280, the network transmits a second selection indication of the one or more selected beam(s), which is received by the user device is step 180. The transmission of step 280 may be performed by a radio access node of the network. In some embodiments, the transmission of step 280 is caused by a control node of the network; e.g., via control signaling to the radio access node.

The second indication may be any suitable indication for identification of the selected beam(s). For example, the second indication may explicitly identify the selected beam(s); e.g., using respective beam indices, or similar. Alternatively or additionally, the second indication may implicitly identify the selected beam(s); e.g., by indicating corresponding selected resource(s) of the second collection, in which case the user device may be configured to map the indicated resource to the corresponding beam.

As illustrated by optional steps 190 and 290, the selected antenna panel(s) and beam(s) may be used for communication (e.g., UL communication) between the user device and the network.

The UL RS triggering signal(s) may be transmitted in any suitable way in steps 230 and 260. For example, the UL RS triggering signal(s) may be comprised in downlink control information (DCI), and/or in a control element for medium access control (MAC-CE), and/or in radio resource control (RRC) signaling.

The UL RSs may be transmitted in any suitable way in steps 140 and 170. For example, an UL RS transmitted in the first collection of resources and/or in the second collection of resources may comprise a sounding reference signal (SRS); e.g., according to periodic SRS transmission, semi-persistent SRS transmission, or aperiodic SRS transmission.

The UL RS transmissions in steps 140 and 170 may comprise using different UL RSs (e.g., different SRSs) for different antenna panels and/or for different beams. This is particularly beneficial for UL RS transmissions in overlapping resources (e.g., simultaneous transmission from two or more antenna panels, or simultaneous transmission of two or more beams).

The first selection indication and/or the second selection indication may be transmitted in any suitable way in steps 250 and 280.

For example, the first selection indication and/or the second selection indication may be comprised in downlink control information (DCI), and/or in a control element for medium access control (MAC-CE), and/or in radio resource control (RRC) signaling.

Alternatively or additionally, the same information field may be used for the first selection indication and the second selection indication. For example, the first selection indication and the second selection indication may be differentiated by using different sets of bit patterns in the information field (e.g., 00 . . . 00 to 01 . . . 11 for panel indication and 10 . . . 00 to 11 . . . 11 for beam indication). Alternatively or additionally, the first selection indication and the second selection indication may be differentiated by using a flag bit to indicate whether panel or beam is referred to. Yet alternatively or additionally, the most recently used resource may be used to differentiate between the first selection indication and the second selection indication (i.e., a most recently used resource of the first collection may define that the selection indication is for antenna panel, and a most recently used resource of the second collection may define that the selection indication is for beam).

According to some embodiments, the user device transmits an UL RS capability message, as illustrated by optional step 110. The UL RS capability message is received by the network, as illustrated by optional step 210. The reception of step 210 may be at a radio access node of the network. In some embodiments, the reception of step 210 is at a control node of the network; e.g., via a radio access node.

Typically, UL RS capability message is transmitted by the user device before receiving the UL RS configuration, and the transmission of the UL RS configuration in step 220 is responsive to the reception of step 210.

The UL RS capability message may be transmitted in any suitable way in step 110. For example, the UL RS capability message may be conveyed by RRC signaling.

The UL RS capability message indicates that the user device supports hierarchical UL beam management; i.e., that it is configurable to perform the transmissions of steps 140 and 170.

Optionally, the UL RS capability message may further indicate other information associated with the hierarchical UL beam management.

For example, the UL RS capability message may indicate a number of antenna panels of the user device. The number of antenna panels may be used to determine a size of the first collection of resources. For example, if a single beam is to be transmitted per antenna panel in step 140, the number of resources in the first collection may equal, or be larger than, the number of antenna panels.

Alternatively or additionally, the UL RS capability message may indicate a number of antenna panels that the user device is capable of transmitting simultaneously from. The number of antenna panels that the user device is capable of transmitting simultaneously from may be used to determine a size of the first collection of resources. For example, if the user device is capable of transmitting simultaneously from two antenna panels, the number of time resources in the first collection may be half of what is needed if the user device is not capable of transmitting simultaneously from antenna panels. Generally, it should be noted that antenna panels with different power control settings are typically beneficially associated with different resources.

Yet alternatively or additionally, the UL RS capability message may indicate a time duration for panel switching. The time duration for panel switching may be used to determine a size of the first collection of resources. For example, the first collection of resources may comprise a sub-set of resources for each antenna panel, wherein there is a time gap between the sub-sets, which time gap equals, or is larger than, the time duration for panel switching.

Yet alternatively or additionally, the UL RS capability message may indicate a number of beams with the second beam width per antenna panel. This number may be the same for all (or some) of the antenna panels, or may differ between all (or some) of the antenna panels. The number of beams with the second beam width per antenna panel may be used to determine a size of the second collection of resources.

For example, if a single antenna panel is to be selected in step 245, the number of resources in the second collection may equal, or be larger than, the number of beams per antenna panel; e.g., the number of resources in the second collection may equal the number of beams of the antenna panels with the most number of beams.

Alternatively or additionally, if a maximum number of antenna panels may be selected in step 245, the number of resources in the second collection may equal the maximum number of antenna panels multiplied with the number of beams of the antenna panels with the most number of beams.

Alternatively, there may be dedicated second collections of resources for each antenna panel, wherein the number of resources in each second collection may equal, or be larger than, the number of beams of the antenna panel it is dedicated to.

Thus, the configuration in relation to the first collection of resources may be based on one or more of: the number of antenna panels of the user device, the number of antenna panels that the user device is capable of transmitting simultaneously from, and the time duration for panel switching, and/or the configuration in relation to the second collection of resources may be based on the number of beams with the second beam width per antenna panel.

In some embodiments, the UL RS capability message may-additionally or alternatively-indicate a number of ports per antenna panel. The number of ports per panel may be used to indicate the first and/or second collection of resources. Using SRS as an example of UL RS, wherein an SRS resource can be configured with one or more SRS ports, the first and/or second collection of resources may depend on whether or not the antenna panels are dual-polarized (one port) or single-polarized (two ports). In the latter case, a resource may be indicated as using one of the two ports.

In some embodiments, the UL RS capability message may-additionally or alternatively-indicate antenna panel identifiers (e.g., indices), and one or more of the above information may be associate with corresponding antenna panel identifier in the UL RS capability message.

The UL RS capability message of step 210 may be transmitted more seldom than (or at least not more often than) the UL RS configuration of step 120. For example, the UL RS capability message of step 210 may be transmitted as part of a registration process performed when a user device registers with the network.

The UL RS configuration of step 120 may be transmitted more seldom than (or at least not more often than) the first UL RSs of step 140. For example, the UL RS configuration of step 120 may be transmitted whenever the network deems it beneficial to apply the suggested approach; e.g., per default for all user devices with UL RS capability, or when the signaling overhead is cumbersome (e.g., when the network is heavily loaded).

The first UL RSs of step 140 may be transmitted more seldom than (or at least not more often than) the second UL RSs of step 170. For example, the first UL RSs of step 140 and/or the second UL RSs of step 170 may be transmitted whenever the network deems it beneficial to evaluate which UL beam to use for communication; e.g., with some periodicity, or event-based (e.g., when UL performance does not fulfill some quality condition). In some embodiment, the UL RSs of step 170 may be primarily used for such an evaluation, and the UL RSs of step 140 may be used for evaluation when an acceptable beam could not be found based on the UL RSs of step 170. Alternatively or additionally, the UL RSs of step 170 may be used for evaluation with a first periodicity and the UL RSs of step 140 may be used for evaluation with a second periodicity, wherein the period of the first periodicity is smaller than the period of the second periodicity.

Thus, transmission of UL RSs with the second beam width in the second collection of resources using the one or more selected antenna panel may occur more often than transmission of UL RSs with the first beam width in the first collection of resources using different ones of the antenna panels occurs.

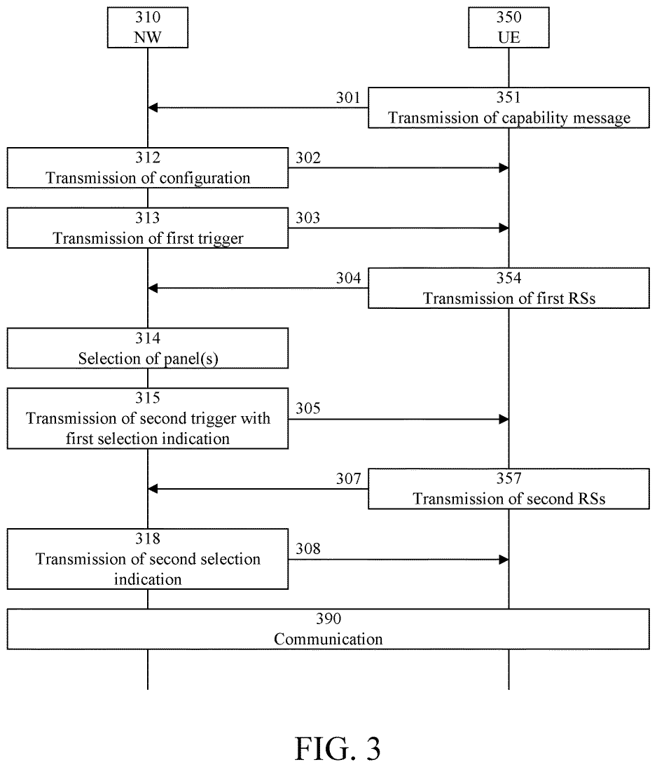

FIG. 3 illustrate example signaling according to some embodiments, between a wireless communication network (NW) 310 and a wireless communication user device (UE) 350 comprising two or more antenna panels. The signaling is for determination of a beam to be used for uplink (UL) communication between the wireless communication user device and the wireless communication network.

In step 351, the user device 350 transmits an UL RS capability message 301 to the network 310 (compare with step 110 of FIG. 1).

In step 312, the network 310 transmits an UL RS configuration 302 for hierarchical UL beam management to the user device 350 (compare with step 220 of FIG. 2).

In step 313, the network 310 transmits a first UL RS triggering signal 303 to the user device 350 (compare with step 230 of FIG. 2).

In step 354, the user device 350 transmits first UL RSs 304 with a relatively broad beam width using different antenna panels (compare with step 140 of FIG. 1), and the network 310 performs measurements on the first UL RSs 304 (compare with step 240 of FIG. 2).

In step 314, antenna panel selection is performed by the network 310 based on the measurements performed on the first UL RSs 304 (compare with step 245 of FIG. 2).

In step 315, the network 310 transmits a second UL RS triggering signal 305—including a first selection indication of the selected antenna panel(s)—to the user device 350 (compare with steps 250 and 260 of FIG. 2).

In step 357, the user device 350 transmits second UL RSs 307 with a relatively narrow beam width using the selected antenna panel(s) (compare with step 170 of FIG. 1), and the network 310 performs measurements on the second UL RSs 307 (compare with step 270 of FIG. 2).

Beam selection is performed by the network 310 based on the measurements performed on the second UL RSs 307 (compare with step 275 of FIG. 2).

In step 318, the network 310 transmits a second selection indication 308 of the selected beam(s) to the user device 350 (compare with step 280 of FIG. 2).

In step 390, the network 310 and the user device 350 communicate using the selected antenna panel(s) and beam(s) (compare with step 190 of FIG. 1 and step 290 of FIG. 2).

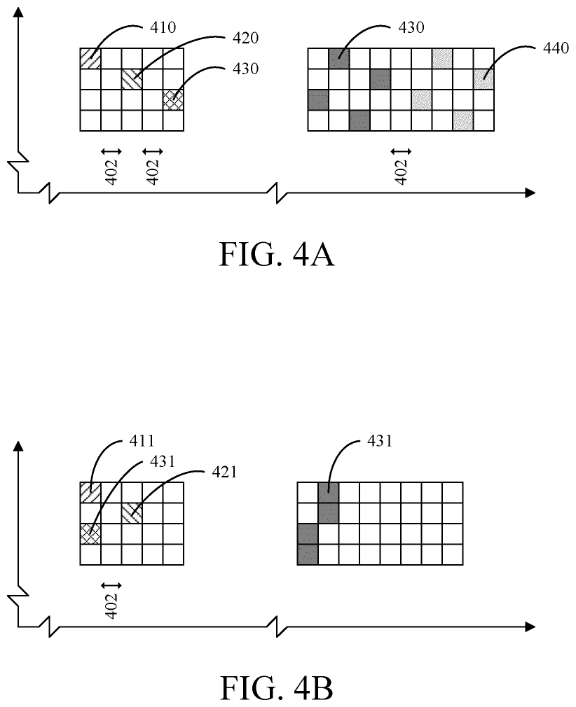

FIG. 4A schematically illustrates example collections of time-frequency resources according to some embodiments. Time is indicated in the x-axis and frequency is indicated on the y-axis, and the time-frequency range of each resource is represented by a rectangle. For example, in an orthogonal frequency division multiplex (OFDM) system, each time-frequency resource may correspond to one or more OFDM-symbols in the time domain and one or more sub-carriers in the frequency domain.

A first collection of resources comprises resources 410, 420, 430 for UL RS per antenna panel (compare with step 140 of FIG. 1). There is a time gap 402 between the different resources to allow for panel switching.

A second collection of resources comprises a first sub-set of resources 430 for beam sweep of a first selected antenna panel and second sub-set of resources 440 for beam sweep of a second selected antenna panel (compare with step 170 of FIG. 1). When it is only possible to select a single antenna panel, there may be only a single set of resources (e.g., 430) for beam sweep of the selected antenna panel.

FIG. 4B schematically illustrates example collections of time-frequency resources according to some embodiments. Time is indicated in the x-axis and frequency is indicated on the y-axis, and the time-frequency range of each resource is represented by a rectangle. For example, in an orthogonal frequency division multiplex (OFDM) system, each time-frequency resource may correspond to one or more OFDM-symbols in the time domain and one or more sub-carriers in the frequency domain.

In this example, the user device can transmit simultaneously from two antenna panels. A first collection of resources comprises resources 411, 421, 431 for UL RS per antenna panel (compare with step 140 of FIG. 1). First and second resources 411, 431 are overlapping in the time domain for the simultaneous transmission from two antenna panels, and the third resource 421 has a time gap 402 in relation to the first and second resources 411, 431 to allow for panel switching.

A second collection of resources comprises a set of resources 431 for beam sweep of a selected antenna panel (compare with step 170 of FIG. 1). In this example, it is assumed that it is only possible to select a single antenna panel, and that the user device can transmit two beams simultaneously from the selected antenna panel.

It should be noted that the examples of FIGS. 4A and 4B are not to be considered as limiting. Contrarily, numerous variations may be envisioned for the first and second collection of resources.

In some embodiments, the UL reference signal configuration for the “panel sweeping procedure” (i.e., the first collection of resources) comprises (e.g., consists of) a single UL-RS resource set, where the number of UL-RS resources in the set is equal to the number of antenna panels. This approach may, for example, be applicable in new radio (NR) for periodic SRS transmission, semi-persistent SRS transmission, and aperiodic SRS transmission (e.g., when the time duration for panel switching is large and there are many antenna panels, so that more than one time slot is needed for the SRS transmission during the “panel sweeping procedure”).

In some embodiments, the UL reference signal configuration for the “panel sweeping procedure” comprises (e.g., consists of) X UL-RS resource sets, each with a single UL-RS resource, where the number of UL-RS resource sets is equal to the number of antenna panels. This approach may, for example, be applicable in NR for aperiodic SRS transmission (e.g., when the time duration for panel switching is large and/or there are many antenna panels, so that more than one time slot is needed for the SRS transmission during the “panel sweeping procedure”).

In some embodiments, the UL reference signal configuration for the “panel sweeping procedure” comprises (e.g., consists of) X UL-RS resources divided into M UL-RS resource sets, where the number of UL-RS resources is equal to the number of antenna panels. This approach may, for example, be applicable in NR for aperiodic SRS transmission (e.g., when the time duration for panel switching is large and/or there are many antenna panels, so that more than one time slot is need for the SRS transmission during the “panel sweeping procedure”).

In some embodiments, the UL reference signal configuration for the “panel sweeping procedure” comprises (e.g., consists of) multiple UL-RS resources for each antenna panel, and the same broad beam (with the first beam width) may be transmitted for all of the UL-RS resources of an antenna panel. Thereby, the wireless communication network can perform reception beam sweeping during the “panel sweeping procedure”.

In some embodiments, the UL reference signal configuration for the “beam sweeping procedure” (i.e., the second collection of resources) comprises (e.g., consists of) a single UL-RS resource set, where the number of UL-RS resources in the set is equal to the number of beams per antenna panel.

In some embodiments, the UL reference signal configuration for the “beam sweeping procedure” comprises (e.g., consists of) two or more UL-RS resource sets, where the number of UL-RS resources is equal to the number of beams per antenna panel.

In some embodiments, when the user device supports simultaneous transmission from N antenna panels, the UL reference signal configuration for the “beam sweeping procedure” comprises (e.g., consists of) N UL-RS resource sets, and the UL-RS resources of each UL-RS resource set will be used for beam sweeping of a corresponding antenna panel.

In some embodiments, when different antenna panels are associated with different number of narrow beams, the UL reference signal configuration for the “beam sweeping procedure” comprises (e.g., consists of) multiple different UL-RS resource sets, each with a number of UL-RS resources depending on the number of beams of a corresponding antenna panel. The “beam sweeping procedure” may then apply a UL-RS resource set that is suitable for each selected antenna panel.

In some embodiments, when different antenna panels are associated with different number of narrow beams, the UL reference signal configuration for the “beam sweeping procedure” comprises (e.g., consists of) a single UL-RS resource set, with a number of UL-RS resources corresponding to the largest number of beams of any of the antenna panels. The “beam sweeping procedure” may then apply the UL-RS resource set and leave any UL-RS resources that exceed the number of beams of any of the selected antenna panels unused.

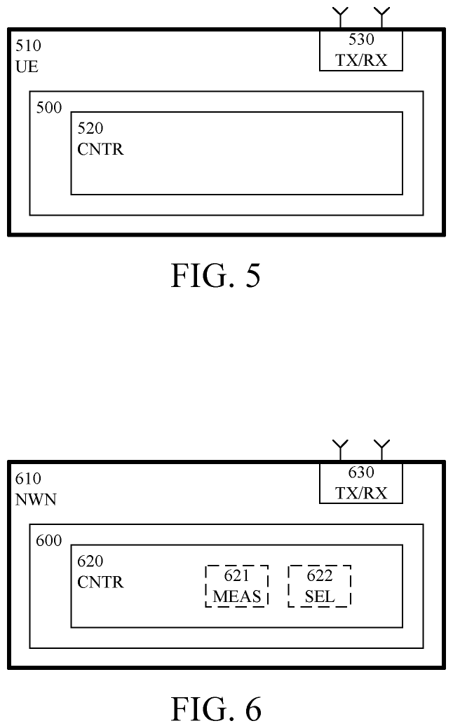

FIG. 5 schematically illustrates an example apparatus 500 according to some embodiments, for determination of a beam to be used for uplink (UL) communication between a wireless communication user device and a wireless communication network.

The apparatus 500 is for a wireless communication user device comprising two or more antenna panels. For example, the apparatus 500 may be comprised, or comprisable, in a UE 510. Alternatively or additionally, the apparatus 500 may be configured to perform, or cause performance of, one or more steps of the method 100 of FIG. 1.

The apparatus comprises a controller (CNTR; e.g., controlling circuitry or a control module) 520.

The controller 520 is configured to cause reception, from the network, of an UL RS configuration for hierarchical UL beam management, wherein the UL RS configuration indicates a first collection of resources and a second collection of resources (compare with step 120 of FIG. 1). For example, the UL RS configuration may be received via a transceiver (TX/RX) 530 of the user device.

The controller 520 is also configured to cause transmission of UL RSs with a first beam width in the first collection of resources using different ones of the antenna panels (compare with step 140 of FIG. 1). For example, the UL RSs may be transmitted via the transceiver (TX/RX) 530.

The controller 520 is also configured to cause reception, from the network, of a first selection indication of one or more selected antenna panel (compare with step 150 of FIG. 1). For example, the first selection indication may be received via the transceiver (TX/RX) 530.

The controller 520 is also configured to cause transmission of UL RSs with a second (more narrow) beam width in the second collection of resources using the one or more selected antenna panel (compare with step 170 of FIG. 1). For example, the UL RSs may be transmitted via the transceiver (TX/RX) 530.

The controller 520 is also configured to cause reception, from the network, of a second selection indication of one or more selected beam (compare with step 180 of FIG. 1). For example, the second selection indication may be received via the transceiver (TX/RX) 530.

FIG. 6 schematically illustrates an example apparatus 600 according to some embodiments, for determination of a beam to be used for uplink (UL) communication between a wireless communication user device comprising two or more antenna panels and a wireless communication network.

The apparatus 600 is for a network node of the wireless communication network. For example, the apparatus 600 may be comprised, or comprisable, in a network node (NWN; e.g., a base station or a control node, such as a coordinating node for multi-TRP or a central processing node for D-MIMO) 610. Alternatively or additionally, the apparatus 600 may be configured to perform, or cause performance of, one or more steps of the method 200 of FIG. 2.

The apparatus comprises a controller (CNTR; e.g., controlling circuitry or a control module) 620.

The controller 620 is configured to cause transmission, to the wireless communication user device, of an UL RS configuration for hierarchical UL beam management, wherein the UL RS configuration indicates a first collection of resources and a second collection of resources (compare with step 220 of FIG. 2). For example, the UL RS configuration may be transmitted via a transceiver (TX/RX) 630 of the network node.

The controller 620 is also configured to cause measurements on UL RSs transmitted by the wireless communication user device with a first beam width in the first collection of resources using different ones of the antenna panels (compare with step 240 of FIG. 2). To this end, the controller 620 may comprise, or be otherwise associated with (e.g., connected, or connectable, to) a measurer (MEAS; e.g., measuring circuitry or a measurement module) 621. The measurer 621 may be configured to perform the measurements.

The controller 620 is also configured to cause selection of one or more antenna panel based on the measurements performed on UL RSs transmitted by the wireless communication user device with a first beam width in the first collection of resources using different ones of the antenna panels (compare with step 245 of FIG. 2). To this end, the controller 620 may comprise, or be otherwise associated with (e.g., connected, or connectable, to) a selector (SEL; e.g., selecting circuitry or a selection module) 622. The selector 622 may be configured to perform the antenna panel selection.

The controller 620 is also configured to cause transmission, to the wireless communication user device, of a first selection indication of the one or more selected antenna panel (compare with step 250 of FIG. 2). For example, the first selection indication may be transmitted via the transceiver (TX/RX) 630.

The controller 620 is also configured to cause measurements on UL RSs transmitted by the wireless communication user device with a second (more narrow) beam width in the second collection of resources using the selected antenna panel(s) (compare with step 270 of FIG. 2). For example, the measurer 621 may be configured to perform the measurements.

The controller 620 is also configured to cause selection of one or more beam based on the measurements performed on UL RSs transmitted by the wireless communication user device with a second beam width in the second collection of resources using the one or more selected antenna panel (compare with step 275 of FIG. 2). For example, the selector 622 may be configured to perform the beam selection.

The controller 620 is also configured to cause transmission, to the wireless communication user device, of a second selection indication of the one or more selected beam (compare with step 280 of FIG. 2). For example, the second selection indication may be transmitted via the transceiver (TX/RX) 630.

It should be noted that features and/or effects described herein in connection to any one of FIGS. 1-3 may be equally applicable-as suitable, and mutatis mutandis-in the context of FIGS. 5-6, even if not explicitly mentioned in connection thereto.

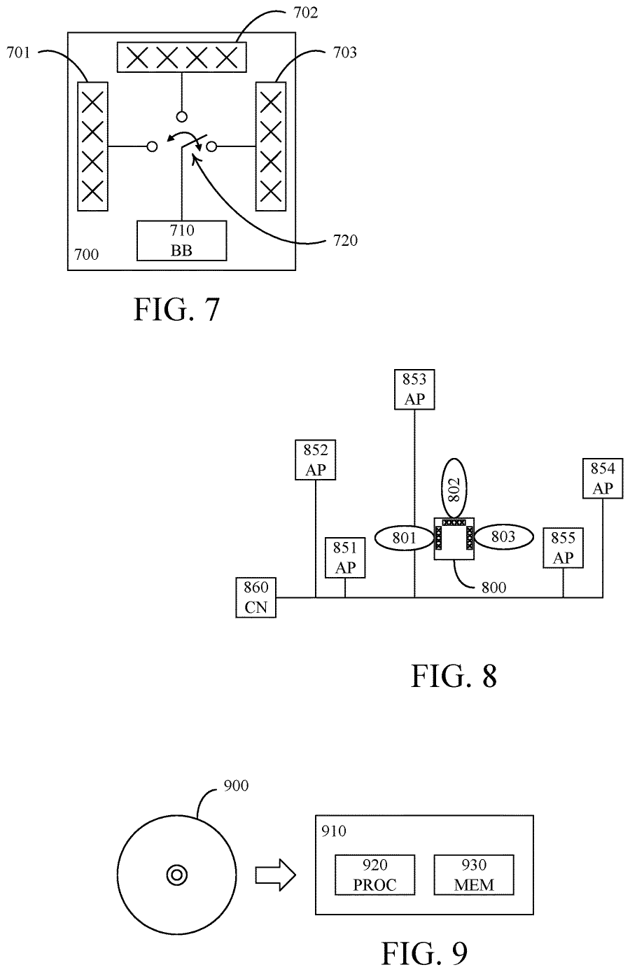

FIG. 7 schematically illustrates an example wireless communication user device 700 according to some embodiments. The user device 700 comprises three antenna panels 701, 702, 703, a baseband processor (BB) 710 and functionality 720 for switching connection of the baseband processor 710 among the antenna panels 701, 702, 703.

For example, the user device 700 may comprise the apparatus 520 of FIG. 5, for determination of a beam to be used for uplink (UL) communication between the user device 700 and a wireless communication network. Alternatively or additionally, the user device 700 may be configured to perform one or more steps of the method 100 of FIG. 1, for determination of a beam to be used for uplink (UL) communication between the user device 700 and the wireless communication network.

FIG. 8 schematically illustrates an example wireless communication context according to some embodiments. The communication context comprises a user device 800 (e.g., the user device 700 of FIG. 7) comprising two or more antenna panels, in a wireless communication network. The wireless communication network comprises a plurality of access points (AP) 851-855 (e.g., D-MIMO APs, or TRPs of a multi-TRP deployment), and a control node (CN) 860 (e.g., a central processing node for D-MIMO, or a coordinating node for multi-TRP).

The user device 800 may comprise the apparatus 520 of FIG. 5, for determination of a beam to be used for uplink (UL) communication between the user device 800 and the wireless communication network. Alternatively or additionally, the user device 800 may be configured to perform, or cause performance of, one or more steps of the method 100 of FIG. 1, for determination of a beam to be used for uplink (UL) communication between the user device 800 and the wireless communication network.

The control node 860 may comprise the apparatus 620 of FIG. 6, for determination of a beam to be used for uplink (UL) communication between the user device 800 and the wireless communication network. Alternatively or additionally, the control node 860 may be configured to perform, or cause performance of, one or more steps of the method 200 of FIG. 2, for determination of a beam to be used for uplink (UL) communication between the user device 800 and the wireless communication network.

Particularly, the user device 800 may be configured to transmit UL RSs with a first beam width in a first collection of resources using the different antenna panels (compare with step 140 of FIG. 1), as illustrated by 801, 802, 803. The control node 860 may be configured to select one or more of the antenna panels (compare with step 245 of FIG. 2) based on measurements performed on the UL RSs 801, 802, 801 by the APs 851-855 (compare with step 240 of FIG. 2).

For example, APs 851 and 855 may measure the highest signal strengths for the UL RSs 801, 802, 801, and may be selected for UL communication. The antenna panel corresponding to UL RS 801 may be selected for AP 851 and the antenna panel corresponding to UL RS 803 may be selected for AP 855, and this selection may be indicated to the user device 800 (compare with step 250 of FIG. 2), which then performs a beam sweep for the selected antenna panels (compare with step 170 of FIG. 1).

It should be noted that features and/or effects described herein in connection to one of the figures may be equally applicable—as suitable, and mutatis mutandis—in the context of any of the other figures, even if not explicitly mentioned in connection thereto.

The described embodiments and their equivalents may be realized in software or hardware or a combination thereof. The embodiments may be performed by general purpose circuitry. Examples of general purpose circuitry include digital signal processors (DSP), central processing units (CPU), co-processor units, field programmable gate arrays (FPGA) and other programmable hardware. Alternatively or additionally, the embodiments may be performed by specialized circuitry, such as application specific integrated circuits (ASIC). The general purpose circuitry and/or the specialized circuitry may, for example, be associated with or comprised in an apparatus such as a wireless communication user device or a network node.

Embodiments may appear within an electronic apparatus (such as a wireless communication user device or a network node) comprising arrangements, circuitry, and/or logic according to any of the embodiments described herein. Alternatively or additionally, an electronic apparatus (such as a wireless communication user device or a network node) may be configured to perform methods according to any of the embodiments described herein.

According to some embodiments, a computer program product comprises a non-transitory computer readable medium such as, for example, a universal serial bus (USB) memory, a plug-in card, an embedded drive, or a read only memory (ROM). FIG. 9 illustrates an example computer readable medium in the form of a compact disc (CD) ROM 900. The computer readable medium has stored thereon a computer program comprising program instructions. The computer program is loadable into a data processor (PROC; e.g., a data processing unit) 920, which may, for example, be comprised in a wireless communication user device or a network node 910. When loaded into the data processor, the computer program may be stored in a memory (MEM) 930 associated with, or comprised in, the data processor. According to some embodiments, the computer program may, when loaded into, and run by, the data processor, cause execution of method steps according to, for example, any of the methods illustrated in FIGS. 1 and 2, or otherwise described herein.

Generally, all terms used herein are to be interpreted according to their ordinary meaning in the relevant technical field, unless a different meaning is clearly given and/or is implied from the context in which it is used.

Reference has been made herein to various embodiments. However, a person skilled in the art would recognize numerous variations to the described embodiments that would still fall within the scope of the claims.

For example, the method embodiments described herein discloses example methods through steps being performed in a certain order. However, it is recognized that these sequences of events may take place in another order without departing from the scope of the claims. Furthermore, some method steps may be performed in parallel even though they have been described as being performed in sequence. Thus, the steps of any methods disclosed herein do not have to be performed in the exact order disclosed, unless a step is explicitly described as following or preceding another step and/or where it is implicit that a step must follow or precede another step.

In the same manner, it should be noted that in the description of embodiments, the partition of functional blocks into particular units is by no means intended as limiting. Contrarily, these partitions are merely examples. Functional blocks described herein as one unit may be split into two or more units. Furthermore, functional blocks described herein as being implemented as two or more units may be merged into fewer (e.g. a single) unit.

Any feature of any of the embodiments disclosed herein may be applied to any other embodiment, wherever suitable. Likewise, any advantage of any of the embodiments may apply to any other embodiments, and vice versa.

Hence, it should be understood that the details of the described embodiments are merely examples brought forward for illustrative purposes, and that all variations that fall within the scope of the claims are intended to be embraced therein.

1-50. (canceled)

51. A method performed by a wireless communication user device for determining a beam to be used for uplink (UL) communication with a wireless communication network, wherein the wireless communication user device comprises two or more antenna panels, the method comprising:
receiving an UL reference signal (RS) configuration for hierarchical UL beam management, wherein the UL RS configuration indicates a first collection of resources and a second collection of resources;
transmitting UL RSs with a first beam width in the first collection of resources using different ones of the antenna panels;
receiving, from the network, a first selection indication of one or more selected antenna panel;
transmitting UL RSs with a second beam width in the second collection of resources using the one or more selected antenna panel, wherein the second beam width is more narrow than the first beam width; and
receiving a second selection indication of one or more selected beam with the second beam width.

52. A method performed by a network node for determining a beam to be used for uplink (UL) communication with a wireless communication user device, wherein the wireless communication user device comprises two or more antenna panels, the method comprising:
causing transmission, to the wireless communication user device, of an UL reference signal (RS) configuration for hierarchical UL beam management, wherein the UL RS configuration indicates a first collection of resources and a second collection of resources;
causing measurements to be performed on UL RSs transmitted by the wireless communication user device with a first beam width in the first collection of resources using different ones of the antenna panels;
selecting one or more antenna panel based on the measurements performed on UL RSs transmitted by the wireless communication user device with a first beam width in the first collection of resources using different ones of the antenna panels;
causing transmission, to the wireless communication user device, of a first selection indication of the one or more selected antenna panel;
causing measurements to be performed on UL RSs transmitted by the wireless communication user device with a second beam width in the second collection of resources using the one or more selected antenna panel, wherein the second beam width is more narrow than the first beam width;
selecting one or more beam based on the measurements performed on UL RSs transmitted by the wireless communication user device with a second beam width in the second collection of resources using the one or more selected antenna panel; and
causing transmission, to the wireless communication user device, of a second selection indication of one or more selected beam with the second beam width.

53. A computer program product comprising a non-transitory computer readable medium, having thereon a computer program comprising program instructions, the computer program being loadable into a data processing unit and configured to cause execution of the method of claim 51 when the computer program is run by the data processing unit.

54. An apparatus for a wireless communication user device, for determination of a beam to be used for uplink (UL) communication with a wireless communication network, wherein the wireless communication user device comprises two or more antenna panels, the apparatus comprising controlling circuitry configured to cause:
reception, from the network, of an UL reference signal (RS) configuration for hierarchical UL beam management, wherein the UL RS configuration indicates a first collection of resources and a second collection of resources;
transmission of UL RSs with a first beam width in the first collection of resources using different ones of the antenna panels;
reception, from the network, of a first selection indication of one or more selected antenna panel;
transmission of UL RSs with a second beam width in the second collection of resources using the one or more selected antenna panel, wherein the second beam width is more narrow than the first beam width; and
reception, from the network, of a second selection indication of one or more selected beam with the second beam width.

55. The apparatus of claim 54, wherein
the controlling circuitry is further configured to cause transmission, before reception of the UL RS configuration, of an UL RS capability message, indicating that the wireless communication user device supports hierarchical UL beam management, and
the UL RS capability message further indicates one or more of: a number of antenna panels of the wireless communication user device, a number of antenna panels that the wireless communication user device is capable of transmitting simultaneously from, a number of beams with the second beam width per antenna panel, and a time duration for panel switching.

56. The apparatus of claim 55, wherein
the configuration in relation to the first collection of resources is based on one or more of: the number of antenna panels of the wireless communication user device, the number of antenna panels that the wireless communication user device is capable of transmitting simultaneously from, and the time duration for panel switching, and/or
the configuration in relation to the second collection of resources is based on the number of beams with the second beam width per antenna panel.

57. The apparatus of claim 54, wherein the controlling circuitry is further configured to cause reception, from the network, of an UL RS triggering signal, and wherein transmission of UL RSs with the first beam width in the first collection of resources using different ones of the antenna panels is responsive to receiving the UL RS triggering signal.

58. The apparatus of claim 54, wherein
the first selection indication and/or the second selection indication is comprised in one or more of: downlink control information, a control element for medium access control, and radio resource control, and/or
a same information field is used for the first selection indication and the second selection indication.

59. The apparatus of claim 54, wherein at least two of the two or more antenna panels of the wireless communication user device are faced in different directions.

60. The apparatus of claim 54, wherein
an UL RS transmitted in the first collection of resources and/or in the second collection of resources comprises a sounding reference signal, and/or
transmission of UL RSs with the second beam width in the second collection of resources using the one or more selected antenna panel occurs more often than transmission of UL RSs with the first beam width in the first collection of resources using different ones of the antenna panels occurs.

61. A wireless communication user device comprising the apparatus of claim 54.

62. An apparatus for a network node, for determination of a beam to be used for uplink (UL) communication with a wireless communication user device, wherein the wireless communication user device comprises two or more antenna panels, the apparatus comprising controlling circuitry configured to cause:
transmission, to the wireless communication user device, of an UL reference signal (RS) configuration for hierarchical UL beam management, wherein the UL RS configuration indicates a first collection of resources and a second collection of resources;
measurements on UL RSs transmitted by the wireless communication user device with a first beam width in the first collection of resources using different ones of the antenna panels;
selection of one or more antenna panel based on the measurements performed on UL RSs transmitted by the wireless communication user device with a first beam width in the first collection of resources using different ones of the antenna panels;
transmission, to the wireless communication user device, of a first selection indication of the one or more selected antenna panel;
measurements on UL RSs transmitted by the wireless communication user device with a second beam width in the second collection of resources using the one or more selected antenna panel, wherein the second beam width is more narrow than the first beam width;
selection of one or more beam based on the measurements performed on UL RSs transmitted by the wireless communication user device with a second beam width in the second collection of resources using the one or more selected antenna panel; and
transmission, to the wireless communication user device, of a second selection indication of one or more selected beam with the second beam width.

63. The apparatus of claim 62, wherein
the controlling circuitry is further configured to cause reception, before transmission of the UL RS configuration, of an UL RS capability message, indicating that the wireless communication user device supports hierarchical UL beam management, and
the UL RS capability message further indicates one or more of: a number of antenna panels of the wireless communication user device, a number of antenna panels that the wireless communication user device is capable of transmitting simultaneously from, a number of beams with the second beam width per antenna panel, and a time duration for panel switching.

64. The apparatus of claim 63, wherein
the configuration in relation to the first collection of resources is based on one or more of: the number of antenna panels of the wireless communication user device, the number of antenna panels that the wireless communication user device is capable of transmitting simultaneously from, and the time duration for panel switching, and/or
the configuration in relation to the second collection of resources is based on the number of beams with the second beam width per antenna panel.

65. The apparatus of claim 62, wherein the controlling circuitry is further configured to cause transmission, to the wireless communication user device, of an UL RS triggering signal to provoke transmission, by the wireless communication user device, of UL RSs with the first beam width in the first collection of resources using different ones of the antenna panels.

66. The apparatus of claim 62, wherein the first selection indication and/or the second selection indication is comprised in one or more of: downlink control information, a control element for medium access control, and radio resource control, and/or
a same information field is used for the first selection indication and the second selection indication.

67. The apparatus of claim 62, wherein selection of one or more antenna panel comprises:
selection of one or more radio access nodes based on the measurements performed on UL RSs transmitted by the wireless communication user device with a first beam width in the first collection of resources using different ones of the antenna panels; and
selection of a corresponding antenna panel for each selected radio access node.

68. The apparatus of claim 62, wherein
an UL RS transmitted in the first collection of resources and/or in the second collection of resources comprises a sounding reference signal, and/or
the controlling circuitry is further configured to cause the wireless communication user device to transmit UL RSs with the second beam width in the second collection of resources using the one or more selected antenna panel occurs more often than UL RSs with the first beam width in the first collection of resources using different ones of the antenna panels occurs.

69. A network node comprising the apparatus of claim 62.

70. The network node of claim 69, wherein the network node is:
a base station;
a coordinating node for multiple transmission points, or
a central processing node for a distributed multiple-input multiple output system.
